(19) United States
(12) Patent Application Publication
(10) Pub. No.: US 2026/0241297 A1
(43) Pub. Date: Aug. 20, 2026

(54) METHODS OF SIMULATING GOLF AND RELATED SYSTEMS AND COMPUTER-READABLE STORAGE MEDIUMS

(71) Applicant: TruGolf Holdings, Inc., Centerville, UT (US)

(72) Inventors: Nathan E. Larsen, Alpine, UT (US); Jacob Stout Johnson, Centerville, UT (US)

(21) Appl. No.: 19/533,638

(22) Filed: Feb. 9, 2026

Related U.S. Application Data
(60) Provisional application No. 63/760,467, filed on Feb. 19, 2025.

(51) Int. Cl. A63F 13/812; A63B 69/36

(52) U.S. Cl. CPC A63F 13/812; A63B 69/3623

(57) ABSTRACT

Methods of simulating golf may involve requesting a first set of data identifying discrete regions of the golf course for simulation from a first database. Generating the instructions for simulating the golf course for simulation may involve defining a playing surface of the golf course for simulation at least partially utilizing the discrete regions, defining features of the golf course for simulation by at least partially utilizing the discrete regions, and generating instructions for populating the features of the golf course for simulation with textures and digital assets corresponding to the at least some of the discrete regions. The instructions for simulating the golf course for simulation may be transmitted for receipt by a client device.

### CROSS-REFERENCE TO RELATED APPLICATIONS

This application claims the benefit under 35 U.S.C. § 119(e) of U.S. Provisional Patent Application Serial No. 63/760,467, filed February 19, 2025, the disclosure of which is hereby incorporated herein in its entirety by this reference.

### TECHNICAL FIELD

This disclosure relates generally to golf simulation and software for providing a simulated golf experience. More specifically, disclosed embodiments relate to techniques for generating golf course for simulation on-demand responsive to user requests, which may enable the creation of higher fidelity golf courses for simulation than other techniques currently known to the inventors.

### BACKGROUND

Golf simulators are used to simulate physical golf play in an at least partially virtual environment. In some golf simulators, a person using the simulator physically swings a golf club at a golf ball, strikes the golf ball, and then observes a simulated golf ball on a virtual golf course. Such simulators are, for example, incorporated into video games and training systems.

### BRIEF SUMMARY

In some examples, computer-readable storage mediums may include instructions that, when executed by a processor, cause the processor to: accept a request to provide a golf course for simulation. A first set of data identifying discrete regions of the golf course for simulation may be requested from a first database. Responsive to receiving the first set of data, instructions for simulating the golf course for simulation may be generated. A playing surface of the golf course for simulation may be defined at least partially utilizing the discrete regions of the first set of data. Features of the golf course for simulation comprising hole location, green area, fairway area, and tee location may be defined at least partially utilizing the discrete regions of the first set of data. Instructions for populating the features of the golf course for simulation with textures from a database of textures and digital assets from a database of digital assets corresponding to the at least some of the discrete regions from the first set of data may be generated. The instructions for simulating the golf course for simulation may be transmitted for receipt by a client device to cause the client device to display and simulate golf played on the golf course for simulation responsive to user input.

In other examples, methods of simulating golf, may involve accepting a request to provide a golf course for simulation. A first set of data identifying discrete regions of the golf course for simulation may be requested from a first database. Responsive to receiving the first set of data, instructions for simulating the golf course for simulation may be generated. A playing surface of the golf course for simulation may be defined at least partially utilizing the discrete regions of the first set of data. Features of the golf course for simulation comprising hole location, green area, fairway area, and tee location may be defined at least partially utilizing the discrete regions of the first set of data. Instructions for populating the features of the golf course for simulation with textures from a database of textures and digital assets from a database of digital assets corresponding to the at least some of the discrete regions from the first set of data may be generated. The instructions for simulating the golf course for simulation may be transmitted for receipt by a client device to cause the client device to display and simulate golf played on the golf course for simulation responsive to user input.

In other examples, systems for simulating golf may include a sensor positioned and configured to detect a trajectory of a ball and a display positioned and configured to display a golf simulation. A processor may be operatively connected to the display and a computer-readable storage medium may be operatively connected to the processor. The computer-readable storage medium may store instructions that, when executed by a processor, cause the system to: accept a request to provide a golf course for simulation. A request for a first set of data identifying discrete regions of the golf course for simulation from a first database may be initiated. Responsive to receipt of the first set of data, generation of instructions for simulating the golf course for simulation may be initiated. Definition of a playing surface of the golf course for simulation at least partially utilizing the discrete regions of the first set of data may be initiated. Definition of features of the golf course for simulation comprising hole location, green area, fairway area, and tee location at least partially utilizing the discrete regions of the first set of data may be initiated. Generation of instructions for populating the features of the golf course for simulation with textures from a database of textures and digital assets from a database of digital assets corresponding to the at least some of the discrete regions from the first set of data may be initiated. The instructions for simulating the golf course for simulation may be received to cause the display to display and the system to simulate golf played on the golf course for simulation responsive to user input received at the sensor.

### BRIEF DESCRIPTION OF THE DRAWINGS

While this disclosure concludes with claims particularly pointing out and distinctly claiming specific examples of subject matter encompassed by this disclosure, various features and advantages of examples within the scope of this disclosure may be more readily ascertained from the following description when read in conjunction with the accompanying drawings. In the drawings, in which like elements have generally been designated with like numerals:

FIG. 1 is a perspective view of an illustrative golf simulator system;

FIG. 2 is a flowchart showing a method of simulating golf;

FIG. 3 is a schematic block diagram of an electronic system which may embody or be included in one or more systems for simulating golf; and

FIG. 4 is a schematic block diagram of a network of electronic systems which may embody, be included in, or be connected to one or more systems for simulating golf.

### DETAILED DESCRIPTION

The illustrations presented in this disclosure are not meant to be actual views of any particular system, apparatus, act in a method, or component thereof, but are merely idealized representations employed to describe illustrative examples. Thus, the drawings are not necessarily to scale.

Disclosed examples relate generally to techniques for generating golf courses for simulation on-demand responsive to user requests, which may enable the creation of higher fidelity golf courses for simulation than other techniques currently known to the inventors. More specifically, disclosed are examples of methods, systems, and software for simulating golf that may involve accepting a user's request to simulate a golf course for which pre-existing instructions for simulating the golf course may not be located within a database of pre-generated golf courses for simulation. A list of golf courses for simulation that may be generated on demand may be presented separately from a list of golf courses for simulation that may be pre-generated utilizing techniques other than those disclosed here (e.g., in separate tabs of an interface for course selection).

Responsive to receiving the request, data for generating the golf course on demand may be obtained. For example, a first set of data identifying discrete regions of the golf course for simulation may be obtained from a first database. The first set of data may include, for example, files containing information representative of the location and shape of various features of a given golf course. For example, the features may include hole location, green area, fairway area, and tee location. In some examples, the features may further include bunker area (e.g., sand trap area), water feature area (e.g., pond area, lake area, river area, stream area), tee box area, rough area, location and/or area(s) of flora (e.g., trees, bushes, cactuses), and/or any combination or subcombination of these.

The first set of data may include coordinates, which may include absolute longitude, absolute latitude, elevation relative to sea level, longitude relative to a selected reference, latitude relative to a selected reference, elevation relative to a reference other than sea level (e.g., referencing the tee or the hole), vector data for connecting coordinates, other instructions for interconnecting coordinates to define an area, a tag or tags for identifying what the coordinates and/or area correspond to, other data for correlating the coordinates and/or area to respective features of the golf course for simulation, or any combination or subcombination of these data. More specifically, the first set of data may include, for example, coordinates in LiDAR, GeoJson, Geospatial Vector Data, Photogrammetry 3D Mesh, various Point Cloud formats, or any combination or subcombination of these coordinate formats. The first set of data may be at a first resolution. For example, the coordinates of the first set of data may be accurate within about 3 m or greater. More specifically, the coordinates of the first set of data may be accurate to between about 3 m and about 10 m of resolution. As a specific, nonlimiting example, the coordinates of the first set of data may be accurate to between about 5 m and about 7 m of resolution.

In some examples, the first set of data may be obtainable from a first database restricting access to authorized users. For example, the first set of data may not be accessible by the general public. More specifically, the first set of data may only be made available responsive to receipt of user credentials corresponding to a database of users authorized to access the first set of data in the first database (e.g., an access token, a username and password, data representative of a biometric scan, a two-factor authentication response, any combination or subcombination of these).

In some examples, the first set of data may not be sufficient on its own to generate a golf course for simulation or may not be sufficient on its own to generate a golf course for simulation of acceptably high quality and fidelity. In some examples where the first set of data is considered sufficient to generate a golf course for simulation, is considered sufficient to generate a golf course for simulation of acceptably high quality, and/or no further data is available for augmenting the first set of data, the golf course for simulation may be generated using only the first set of data. In other examples, a second set of data may also be obtained from a second database and used in conjunction with the first set of data to generate the golf course for simulation.

The second set of data may include, for example, files containing information identifying geographical coordinates representative of the golf course for simulation from a second database. For example, the geographical coordinates may include information representative of a playing surface of the golf course for simulation. In some examples, the geographical coordinates of the second set of data may lack information representative of the location and shape of various features of a given golf course. For example, the second set of data may not indicate hole location, green area, fairway area, tee location, bunker area (e.g., sand trap area), tee box area, and/or rough area. In some other examples, second set of data may include some features of a given golf course, but not others. For example, the second set of data may include water feature area (e.g., pond area, lake area, river area, stream area), location and/or area(s) of flora (e.g., trees, bushes, cactuses), any of the other features discussed above as not being within the second set of data in some other examples, and/or any combination or subcombination of these. In still other examples, the second set of data may include all the foregoing features.

The second set of data may likewise include coordinates, which may include absolute longitude, absolute latitude, elevation relative to sea level, longitude relative to a selected reference, latitude relative to a selected reference, elevation relative to a reference other than sea level (e.g., referencing the tee or the hole), vector data for connecting coordinates, other instructions for interconnecting coordinates to define an area, a tag or tags for identifying what the coordinates and/or area correspond to, other data for correlating the coordinates and/or area to respective features of the golf course for simulation, or any combination or subcombination of these data. More specifically, the second set of data may include, for example, coordinates in LiDAR, GeoJson, Geospatial Vector Data, Photogrammetry 3D Mesh, various Point Cloud formats, or any combination or subcombination of these coordinate formats. The second set of data may be at a second resolution different from the first resolution. In some examples, the second resolution may be more detailed than the first resolution. For example, the coordinates of the second set of data may be accurate within about 3 m or less. More specifically, the coordinates of the first set of data may be accurate to between about 0.1 m and about 2 m of resolution. As a specific, nonlimiting example, the coordinates of the first set of data may be accurate to between about 0.25 m and about 1 m of resolution (e.g., about 0.5 m of resolution).

In some examples, the second set of data may be obtainable from a second database accessible without restriction. For example, the second set of data may be accessible by the general public. More specifically, the second set of data may be made available responsive to receipt of receipt of a request to access the second set of data in the second database (e.g., a query).

Like certain examples of the first set of data, the second set of data may not always be sufficient on its own to generate a golf course for simulation or may not be sufficient on its own to generate a golf course for simulation of acceptably high quality and fidelity. In some examples where the second set of data is considered sufficient to generate a golf course for simulation, is considered sufficient to generate a golf course for simulation of acceptably high quality, and/or no further data is available for augmenting the second set of data, the golf course for simulation may be generated using only the second set of data. In other examples, the first set of data may also be obtained from the first database and used in conjunction with the second set of data to generate the golf course for simulation.

In some examples, the first set of data and the second set of data may be utilized to generate a golf course for simulation. For example, some or all of the first set of data may be combined with some or all of the second set of data to generate a file containing data representative of the golf course for simulation, including its features and playing surface. In some examples, some or all of the features of the golf course for simulation from the first set of data may be combined with some or all of the playing surface of the golf course for simulation from the second set of data. More specifically, some or all of the features of the golf course for simulation from the first set of data may be, for example, rendered smoother than they appear in the first set of data alone or made more accurate or higher resolution than achievable using the first set of data alone utilizing information from the second set of data. As a specific, nonlimiting example, instructions for simulating the golf course for simulation may be generated responsive to receiving the first set of data and the second set of data by: (1) defining a playing surface of the golf course for simulation utilizing the discrete regions of the first set of data, optionally as corrected, smoothed out, or made more accurate or higher resolution utilizing the second set of data; (2) defining features of the golf course for simulation including hole location, green area, fairway area, and tee location at least partially utilizing the discrete regions of the first set of data; and (3) generating instructions for populating the features of the golf course for simulation with textures from a database of textures and digital assets from a database of digital assets corresponding to the at least some of the discrete regions from the first set of data.

In some examples, generating the golf course for simulation may involve first prioritizing data representative of the features of the golf course for simulation and then prioritizing data representative of the playing surface of the golf course for simulation having the highest resolution among available data. By first seeking to populate the golf course for simulation with as complete a set of landscaping features as can be identified utilizing the data available, and placing those features on as detailed and accurate a playing surface as can be generated utilizing the data available. In examples where the first set of data includes the features and is generally of lower resolution, and the second set of data lacks the features and is generally of higher resolution, such prioritization may mean that the features may be extracted from the first set of data, and the playing surface may be defined from the first set of data as improved in light of the second set of data.

Using techniques in accordance with this disclosure to generate the golf course for simulation may produce a higher resolution, higher fidelity, more densely populated with features, and/or more accurate golf simulation when compared to golf courses for simulation generated using other techniques known to the inventors. For example, techniques in accordance with this disclosure may enable on-demand generation of a golf course for simulation when pregenerated data representative of the golf course for simulation is not available or when generating the golf course for simulation on demand would result in improved player experience. In addition, generating golf courses for simulation on demand may enable golf simulation to be provided for a much wider variety of golf courses, such as, for example, courses that are local to a user, courses that are not part of a professional tour, courses that are not famous, and courses that have not been analyzed by the provider of the golf simulation. Generating such golf courses for simulation on demand may reduce the need to gather and process detailed scan data for a golf course and may reduce the need to generate custom digital assets, such as, for example, custom trees or other flora, to represent the golf course for simulation.

As used herein, the terms “substantially” and “about” in reference to a given parameter, property, or condition means and includes to a degree that one of ordinary skill in the art would understand that the given parameter, property, or condition is met with a degree of variance, such as within acceptable manufacturing tolerances. For example, a parameter that is substantially or about a specified value may be at least about 90% the specified value, at least about 95% the specified value, at least about 99% the specified value, or even at least about 99.9% the specified value.

As used herein, the terms “computer-readable storage medium,” “memory device,” and “memory” mean and include microelectronic devices exhibiting, but not limited to, memory and data storage functionality, and exclude embodiments encompassing transitory signals. For example, a system on a chip (SoC) is encompassed in the meaning of computer-readable storage medium. By way of non-limiting examples, computer-readable storage media may generally include packaged semiconductor devices having memory functionality and storing instructions for operating golf simulators as described herein, unless otherwise specified. More specific examples of memory devices include spin torque transfer magnetic random access memory (STT-MRAM), magnetic random access memory (MRAM), dynamic random access memory (DRAM) (e.g., synchronous DRAM (SDRAM)) conforming with a double data rate (DDR) and/or graphics DDR (GDDR) standard (DDR4, DDR5, DDR6), static random access memory (SRAM), racetrack memory, read-only memory (ROM) such as an erasable programmable read-only memory (EPROM), resistive read-only memory (RROM), flash memory, and other known memory types.

The term “area,” as used herein in reference to a feature of a golf course for simulation, means and includes a contiguous surface that, when projected onto a two-dimensional surface, forms an enclosed shape or a grouping of enclosed shapes. For example, areas may be measured in square meters (or other squared distances) and may exhibit variations in elevation.

The term “location,” as used herein in reference to a feature of a golf course for simulation, means and includes a point, which may be defined in terms of absolute position or position relative to other features, and which may be representative of a geometric center of a larger feature (e.g., a hole, a tee box, a tree). For example, locations may be defined in terms of latitude, longitude, and elevation, or other coordinates on a defined coordinate system.

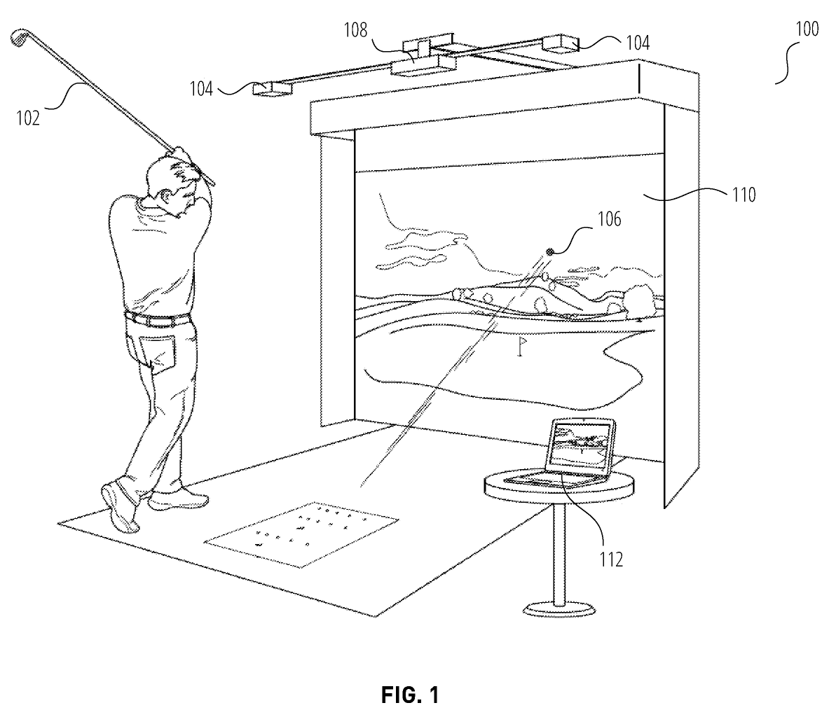

FIG. 1 is a perspective view of an example golf simulator 100. The golf simulator system 100 may include a golf club 102 and one or more first sensors 104, one or more second sensors 108, or one or more first sensors 104 and one or more second sensors 108 positioned, oriented, and configured to detect the trajectory of a ball 106 (e.g., a golf ball) struck by the golf club 102. The golf simulator system 100 may also include a display 110, which may be operably coupled to a computer 112, where the computer 112 may include a processor and a computer-readable storage medium storing executable instructions. The display 110 may be positioned, oriented, and configured to display a golf simulation. In some examples, the display 110 may include a projector configured to project images onto a surface. In some examples, the golf simulator system 100 may also optionally include an enclosure located at least partially around other components of the golf simulator system 100, such as, for example, a tent, a partition, a room, a building.

Each first sensor 104, each second sensor 108, or each first sensor 104 and each second sensor 108 may be positioned, oriented, and configured to detect at least a portion of a trajectory of a ball 106. In some embodiments, each first sensor 104, each second sensor 108, or each first sensor 104 and each second sensor 108 may include a high-speed camera that, upon detecting a collision between the golf club 102 and the ball 106, captures the action or use by acquiring a series of images using very brief exposures. For example, in some embodiments, each first sensor 104, each second sensor 108, or each first sensor 104 and each second sensor 108 may capture image data at exposures less than or equal to 1/1000 of a second or with a frame capture rate greater than or equal to 250 frames per second (FPS). In some embodiments, each first sensor 104, each second sensor 108, or each first sensor 104 and each second sensor 108 may have a capture rate in a range extending from about 2500 FPS to about 3000 FPS.

In some embodiments, each first sensor 104, each second sensor 108, or each first sensor 104 and each second sensor 108 may be configured to capture an interaction between a ball 106 and a golf club 102. Each first sensor 104, each second sensor 108, or each first sensor 104 and each second sensor 108 may be configured to detect, for example, the movement of a ball 106, such as, for example, its speed, direction of travel, acceleration, spin, deformation, or any combination or subcombination of these. In some examples, each first sensor 104, each second sensor 108, or each first sensor 104 and each second sensor 108 may be configured to detect at least one of club head speed, ball flight trajectory, ball travel distance, club face angle, ball flight velocity, ball flight acceleration, or ball deformation. As a specific, nonlimiting example, each first sensor 104 may be positioned, oriented, and configured to at least partially detect a speed and direction of travel of the ball 106 and the speed and face angle of the head of the golf club 102. Continuing the specific, nonlimiting example, each second sensor 108 may be positioned, oriented, and configured to at least partially detect a spin of the ball 106.

In some examples, each first sensor 104, each second sensor 108, or each first sensor 104 and each second sensor 108 may include a memory device to store captured images. For example, each first sensor 104, each second sensor 108, or each first sensor 104 and each second sensor 108 may be configured to capture image data for a predefined period of time such as the entirety of a detected use or action of a golf club 102 and/or ball 106. Each first sensor 104, each second sensor 108, or each first sensor 104 and each second sensor 108 may be configured to store all images associated with that period of time in memory. The memory device may be accessible by a processor of the golf simulator system 100 for analysis.

In some embodiments, each first sensor 104 and each second sensor 108 may be combined into a single sensor, a single housing, and/or a single device. For example, each first sensor 104 and each second sensor 108 may be the same sensor of a camera where the camera may be used both for capturing an interaction between ball 106 and a golf club 102. In other examples, each first sensor 104 and each second sensor 108 may be separate sensors, located in distinct housings, and/or provided in separate devices. For example, each first sensor 104 may be located in a first camera or group of first cameras and each second sensor 108 may be located in a second camera or group of second cameras.

Examples of golf simulator systems 100 suitable for providing golf simulation in accordance with this disclosure may be available from TruGolf, Inc., of 60 North 1400 West, Centerville, Utah 84104.

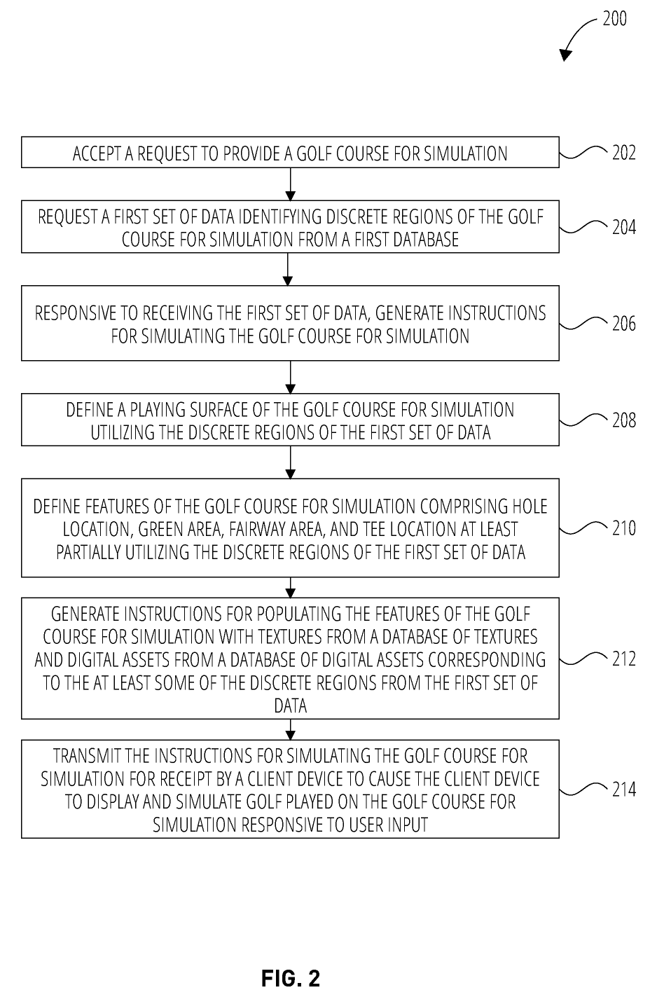

FIG. 2 is a flowchart showing a method 200 of simulating golf, which may utilize a golf simulator system, such as, for example, the golf simulator system 100 shown in FIG. 1. The method 200 may involve, for example, accepting a request to provide a golf course for simulation, as indicated at act 202. For example, a menu presenting golf courses available for simulation may be presented in a graphical user interface of a display of the computer 112 and/or in the display 110 of the golf simulator system 100 of FIG. 1. In some examples, the menu may include a first section (e.g., a tab) showing pregenerated golf courses for simulation that may be provided via the golf simulator system 100. A second, different section of the menu (e.g., a second, different tab) may show golf courses for simulation that are not pregenerated and that may be generated on demand for simulation by the golf simulator system 100. In other examples, all golf courses available for simulation, including any pregenerated courses and any not yet generated courses, may be presented in the same menu or list.

Accepting the request may involve, for example, receiving user input via the golf simulator system 100. More specifically, accepting the request may involve receiving user input via, for example, one or more peripheral devices of the golf simulator system 100, such as, for example, a keyboard, mouse, touch pad, microphone, camera, optical sensor, infrared sensor, or other appropriate switch or sensor. As specific, nonlimiting examples, accepting the request may involve receiving a key press at a keyboard, a click of a mouse, a press or tap of a touch pad, a voice command received at a microphone, or a gesture command received at an appropriate sensor (e.g., a camera, an optical sensor, an infrared sensor).

The method 200 may further involve requesting a first set of data identifying discrete regions of the golf course for simulation from a first database, as indicated at act 204. The discrete regions identified in the first set of data may include, for example, information representative of the location, shape, orientation, or any combination or subcombination of location, shape, and orientation of various features of a given golf course, such as the golf course to be simulated selected by the user. For example, the features may include hole location, green area, fairway area, tee location, and/or any combination or subcombination of these. In some examples, the features may further include bunker area (e.g., sand trap area), water feature area (e.g., pond area, lake area, river area, stream area), tee box area, tee location within the tee box area (which may be set responsive to receiving user input selecting the location of the tee), rough area, location and/or area(s) of flora (e.g., trees, bushes, cactuses), and/or any combination or subcombination of these.

The first set of data may include coordinates, which may include absolute longitude, absolute latitude, elevation relative to sea level, longitude relative to a selected reference, latitude relative to a selected reference, elevation relative to a reference other than sea level (e.g., referencing the tee, the tee box, or the hole), vector data for connecting coordinates, other instructions for interconnecting coordinates to define an area, a tag or tags for identifying what the coordinates and/or area correspond to, other data for correlating the coordinates and/or area to respective features of the golf course for simulation, or any combination or subcombination of these data. More specifically, the first set of data may include, for example, coordinates in LiDAR, GeoJson, Geospatial Vector Data, Photogrammetry 3D Mesh, various Point Cloud formats, or any combination or subcombination of these coordinate formats.

The first set of data may be at a first resolution. For example, the coordinates of the first set of data may be accurate within about 3 m or greater. More specifically, the coordinates of the first set of data may be accurate to between about 3 m and about 10 m of resolution. As a specific, nonlimiting example, the coordinates of the first set of data may be accurate to between about 5 m and about 7 m of resolution.

In some examples, the first set of data may be obtainable from a first database restricting access to authorized users. For example, the first set of data may not be accessible by the general public. More specifically, the first set of data may only be made available responsive to receipt of user credentials corresponding to a database of users authorized to access the first set of data in the first database (e.g., an access token, a username and password, data representative of a biometric scan, a two-factor authentication response, any combination or subcombination of these).

Issuing the request for the first set of data may involve, for example, sending a communication over a network (e.g., a local area network (LAN), a wide area network (WAN), the Internet) utilizing an appropriate communication protocol (e.g., hypertext transfer protocol secure (HTTPS)). In some examples, a computer 112 (see FIG. 1) of a golf simulator system 100 (see FIG. 1) may directly issue the request, which may be routed over the network to the appropriate host of the first database (e.g., a server, a network-attached storage (NAS)). In other examples, the computer 112 (see FIG. 1) of the golf simulator system 100 (see FIG. 1) may initiate the request; the request may first be received at a first server (e.g., hosted by a provider of the golf simulation to the golf simulator system 100 (see FIG. 1)). The first server may then issue the request for routing to the appropriate host of the first database (e.g., a second server, a network-attached storage (NAS)). In still other examples, the request may be issued directly by a first server (e.g., hosted by a provider of the golf simulation to the golf simulator system 100 (see FIG. 1)) without any specific prompt from a client device. The request issued by the first server may be sent to the appropriate host of the first database (e.g., a second server, a network-attached storage (NAS)).

A second set of data identifying geographical coordinates representative of the golf course for simulation may be requested from a second database in some examples. For example, the geographical coordinates may include information representative of a playing surface of the golf course for simulation. In some examples, the geographical coordinates of the second set of data may lack information representative of the location and shape of various features of a given golf course. For example, the second set of data may not indicate hole location, green area, fairway area, tee location, bunker area (e.g., sand trap area), tee box area, and/or rough area. In some other examples, second set of data may include some features of a given golf course, but not others. For example, the second set of data may include water feature area (e.g., pond area, lake area, river area, stream area), location and/or area(s) of flora (e.g., trees, bushes, cactuses), any of the other features discussed above as not being within the second set of data in some other examples, and/or any combination or subcombination of these. In still other examples, the second set of data may include all the foregoing features.

Like the first set of data, the second set of data may include coordinates, which may include absolute longitude, absolute latitude, elevation relative to sea level, longitude relative to a selected reference, latitude relative to a selected reference, elevation relative to a reference other than sea level (e.g., referencing the tee or the hole), vector data for connecting coordinates, other instructions for interconnecting coordinates to define an area, a tag or tags for identifying what the coordinates and/or area correspond to, other data for correlating the coordinates and/or area to respective features of the golf course for simulation, or any combination or subcombination of these data. More specifically, the second set of data may include, for example, coordinates in LiDAR, GeoJson, Geospatial Vector Data, Photogrammetry 3D Mesh, various Point Cloud formats, or any combination or subcombination of these coordinate formats.

The second set of data may be at a second resolution different from the first resolution. In some examples, the second resolution may be more detailed than the first resolution. For example, the coordinates of the second set of data may be accurate within about 3 m or less. More specifically, the coordinates of the first set of data may be accurate to between about 0.1 m and about 2 m of resolution. As a specific, nonlimiting example, the coordinates of the first set of data may be accurate to between about 0.25 m and about 1 m of resolution (e.g., about 0.5 m of resolution).

In some examples, the second set of data may be obtainable from a second database accessible without restriction. For example, the second set of data may be accessible by the general public. More specifically, the second set of data may be made available responsive to receipt of a request to access the second set of data in the second database (e.g., a query) without provision of any access credentials.

Issuing the request for the second set of data may involve, for example, sending a communication over a network (e.g., a local area network (LAN), a wide area network (WAN), the Internet) utilizing an appropriate communication protocol (e.g., hypertext transfer protocol secure (HTTPS)). In some examples, a computer 112 (see FIG. 1) of a golf simulator system 100 (see FIG. 1) may directly issue the request, which may be routed over the network to the appropriate host of the first database (e.g., a server, a network-attached storage (NAS)). In other examples, the computer 112 (see FIG. 1) of the golf simulator system 100 (see FIG. 1) may initiate the request; the request may first be received at a first server (e.g., hosted by a provider of the golf simulation to the golf simulator system 100 (see FIG. 1)). The first server may then issue the request for routing to the appropriate host of the first database (e.g., a second server, a network-attached storage (NAS)). In still other examples, the request may be issued directly by a first server (e.g., hosted by a provider of the golf simulation to the golf simulator system 100 (see FIG. 1)) without any specific prompt from a client device. The request issued by the first server may be sent to the appropriate host of the first database (e.g., a second server, a network-attached storage (NAS)).

In some examples, the method may preferentially first request the second set of data from a private database comprising confidential scan data. For example, some golf courses available for simulation may be pregenerated utilizing scan data that is proprietary to the simulation provider. If such data is available, the second set of data may be pulled from that scan data instead of other sources, such as publicly available databases. If the private database does not include confidential scan data corresponding to the golf course for simulation, the second set of data may be requested from, for example, a public database comprising global positioning system data. Suitable private databases may available from, for example, iGolf, Inc., of San Diego, California, U.S.A. Suitable public databases may be available from, for example, Google Earth of Alphabet Inc., of Mountain View, California, and OpenStreetMap available at https://www.openstreetmap.org/.

Responsive to receiving the first set of data instructions for simulating the golf course for simulation may be generated, as indicated at act 206. For example, the first set of data, the second set of data, or the first and second sets of data may be utilized to generate a golf course for simulation. More specifically, some or all of the first set of data may be combined, for example, with some or all of the second set of data to generate a file containing data representative of the golf course for simulation, including its features and playing surface in some examples. In some examples, some or all of the playing surface and features of the golf course for simulation from the first set of data may be combined with some or all of the playing surface of the golf course for simulation from the second set of data. More specifically, some or all of the playing surface and features of the golf course for simulation from the first set of data may be, for example, refined, revised, or replaced utilizing corresponding portions of the playing surface of the golf course for simulation from the second set of data. As a specific, nonlimiting example, instructions for simulating the golf course for simulation may be generated responsive to receiving the first set of data and the second set of data by: (1) defining a playing surface of the golf course for simulation utilizing the discrete regions of the first set of data (at act 208); (2) defining features of the golf course for simulation including hole location, green area, fairway area, and tee location at least partially utilizing the discrete regions of the first set of data (at act 210); and (3) generating instructions for populating the features of the golf course for simulation with textures from a database of textures and digital assets from a database of digital assets corresponding to the at least some of the discrete regions from the first set of data (at act 212).

In some examples, generating the golf course for simulation may involve first prioritizing data representative of the features of the golf course for simulation and then prioritizing data representative of the playing surface of the golf course for simulation having the highest resolution among available data. By first seeking to populate the golf course for simulation with as complete a set of landscaping features as can be identified utilizing the data available, and placing those features on as detailed and accurate a playing surface as can be generated utilizing the data available. In examples where the first set of data includes the features and is generally of lower resolution, and the second set of data lacks the features and is generally of higher resolution, such prioritization may generally mean that the features may be extracted from the first set of data, and the playing surface may be refined, revised, or replaced, at least in part, utilizing the second set of data.

Generating the instructions for simulating the golf course for simulation may involve, for example, parsing, analyzing, and utilizing at least portions of the first set of data, the second set of data, or the first set of data and the second set of data to produce a set of instructions for simulating the golf course. For example, the resulting instructions may include absolute longitude, absolute latitude, elevation relative to sea level, longitude relative to a selected reference, latitude relative to a selected reference, elevation relative to a reference other than sea level (e.g., referencing the tee or the hole), vector data for connecting coordinates, other instructions for interconnecting coordinates to define an area, a tag or tags for identifying what the coordinates and/or area correspond to, other data for correlating the coordinates and/or area to respective features of the golf course for simulation, or any combination or subcombination of these data. More specifically, the instructions for simulating the golf course may include, for example, coordinates in LiDAR, GeoJson, Geospatial Vector Data, Photogrammetry 3D Mesh, various Point Cloud formats, or any combination or subcombination of these coordinate formats, with tags for populating discrete regions of the golf course with appropriate digital assets corresponding to features of the golf course for simulation.

In some examples where both the first set of data and the second set of data are used to generate instructions for simulating the golf course, the first set of data may be compared to the second set of data. Differences in the first set of data and the second set of data may be reconciled when generating the instructions for simulating the golf course. For example, the shape, position, or shape and position of the discrete regions of the golf course for simulation may be modified responsive to detected shapes and positions of the geographical coordinates representative of the golf course for simulation before defining the features of the golf course for simulation. More specifically, the shape, position, or shape and position of the discrete regions of the golf course for simulation may be modified by, for example, comparing first elevation data, first position data, and/or first orientation data from the first set of data to corresponding second elevation data, second position data, and/or second orientation data from the second set of data and, when the relevant first data does not match the associated second data, using the data from whichever set of data has a more detailed resolution (e.g., the second data) for the playing surface and for the features of the golf course for simulation.

In some examples where the both the first set of data and the second set of data are used to generate instructions for simulating the golf course, at least one transition between the discrete regions of the first set of data or between the discrete regions of the first set of data and a surrounding environment may be rendered smoother utilizing the geographical coordinates of the second set of data when defining the playing surface of the golf course for simulation. For example, a transition region between regions of different elevation may be defined, and a playing surface for that transition region may be generated. Where gradual changes in slope are expected, such as, for example, on fairways and in lowlands and plains, the transition region may extend for long distances (e.g., about 3 m or more, between about 3 m and about 10 m), may overlap with and replace large portions of the adjacent regions (e.g., about 1 m or more, between about 1 m and about 2 m), and may have a gentle slope (e.g., about 25° or less, between about 0° and about 25°, between about 5° and about 15°). Where intermediate changes in slope are expected, such as, for example, near water hazards, sand traps, rocks, and near borders of the playable regions of the golf course, the transition region may extend for intermediate distances (e.g., between about 1 m and about 3 m), may overlap with and replace intermediate portions of the adjacent regions (e.g., between about 0.5 m and about 1 m), and may have an intermediate slope (e.g., between about 25° and about 45°). Where large changes in slope are expected, such as, for example, in mountainous and cliff-adjacent regions and outside the playable regions of the golf course, the transition region may extend for short distances (e.g., about 1 m or less, between about 0.1 m and about 1 m), may overlap with and replace small portions of the adjacent regions (e.g., less than about 0.5 m, between about 0.1 m and about 0.5 m), and may have a steep slope (e.g., about 45° or greater, between about 45° and about 75°).

When making the transition, variable slope (e.g. continuously variable slope) may be used to present a smooth playing surface in some examples. In some examples, interpolation between points may be utilized to assist in forming a smooth transition among playing surfaces and regions. For example, polynomial interpolation, spline interpolation, or mimetic interpolation may be utilized when defining a playing surface from the first set of data, the second set of data, or the first set of data and the second set of data.

In some examples, textures and digital assets representative of flora prevalent in and around the geographical coordinates of the second set of data may be included when generating the instructions for populating the features of the golf course for simulation with the textures and the digital assets. For example, textures and feature models representative of desert flora (e.g., cactus, Joshua tree, yucca, succulents), mountainous flora (e.g., conifer trees, aspen trees, birch trees, wildflowers), tropical flora (e.g., ferns, palm trees, banana trees, mango trees, papaya trees, cocoa trees, rainbow eucalyptus trees, rubber trees, kapok trees, vines, orchids), plains flora (e.g., grasses), forest flora (e.g., deciduous trees), beach flora (e.g., beach vines, beach grasses), or other flora present at the latitude, longitude, and elevation corresponding to the geographical coordinates of the first set of data, the second set of data, or the first set of data and the second set of data may be utilized to more accurately represent the corresponding flora in associated discrete regions (e.g., rough areas, surrounding environment) of the golf course for simulation. The digital assets may include, for example, pregenerated three-dimensional assets, such as, for example, models of trees, rocks, cactuses, and other features, and may have a hit volume (e.g., a hit box) with which objects in the simulated golf course may interact. The digital assets may also include, for example, dynamically generated three-dimensional assets, including those types of assets discussed in connection with the pregenerated assets, which may be generated following rulesets.

In some examples, the flora may be varied responsive to a season currently active in the location where the golf course is located, to reduce repetition, or both. For example, flora may be less prevalent, may be presented as less lush, and/or may be presented in more muted or other seasonally appropriate colors when it is cold where the golf course is located and may be more prevalent, may be presented as more lush, and/or may be presented in more vibrant or other seasonally appropriate colors when it is warm where the golf course is located. In addition adjacency of flora having identical texture and/or digital assets (e.g., three-dimensional models) may be avoided or prohibited to reduce unnatural repetition.

In some examples, textures and digital assets representative of terrain prevalent in and around the geographical coordinates of the first set of data, the second set of data, or the first set of data and the second set of data may be included when generating the instructions for populating the features of the golf course for simulation with the textures and the digital assets. For example, mountainous, plains, steppe, mesa, hilly, beach, forest, tropical forest, rocky, gravel, sandy, dune, or other appropriate local terrain may be selected to populate the surrounding area of the golf course for simulation when such terrain corresponds to the geographical coordinates of the first set of data, the second set of data, or the first set of data and the second set of data.

In some examples, at least some of the features of the golf course for simulation may be defined by positioning dynamically, on-the-fly generated features other than hole location, green area, fairway area, and tee location within the golf course for simulation. Neither the first set of data nor the second set of data may include detailed information about the inclusion or location of certain features, such as, for example, flora and terrain present on and around the playable area of the golf course to be simulated. Features may be selected for dynamic, on-the-fly placement on the golf course by analyzing the adjacent regions in some examples. For example, flora and terrain commonly encountered near water (e.g., reeds, banks) may be dynamically positioned adjacent to water features and water hazards, flora and terrain commonly encountered near the borders of the course (e.g., trees, tall grass, bushes, rocks) may be dynamically positioned adjacent to the rough and on a side of the rough opposite the fairway or green. Feature placement may involve including tags at locations within the play area of the golf course to be simulated, which may then be populated with corresponding textures and digital assets. By populating the golf course for simulation with such dynamically added features, the process may increase visual interest, better correspond to expected real conditions, and reduce barren, featureless presentation of golf courses.

In some examples, images corresponding to the golf course to be simulated from the first set of data, the second set of data, or the first set of data and the second set of data may be analyzed utilizing an artificial intelligence model trained to identify the features of the golf course. For example, AI-assisted image-recognition software may be utilized to identify features within images provided from the first set of data, the second set of data, or the first set of data and the second set of data, which features may include, for example, prominent trees, rocks, or other foliage or terrain that is viewable in the images, but may not otherwise be included in the data (e.g., may not appear as a separate object or tag). Responsive to identifying one or more features from the images not already present in the first set of data or the second set of data, one or more of the identified features may be included when defining the features of the golf course for simulation (e.g., by placing a tag where the feature is located for population by corresponding textures and digital assets).

In some examples, placement of features in locations that would render the simulation unplayable or less enjoyable may be avoided or prohibited. For example, large flora and unplayable terrain may not be placed between a fairway and a green. In some examples, feature placement may be variable, such as, for example, responsive to selection of difficulty levels or strategic goals. For example, the frequency of water features, water hazards, and bunkers may be increased, or their location made closer to or more overlapping with a shortest expected path between a tee and a green, at higher difficulty levels.

In some examples, textures between distinct regions may be blended with one another, such as, for example, using a gradient, to reduce harsh transitions. In situations where a harsh transition may be expected, such as, for example, between water features, water hazards, and bunkers and a remainder of the course, no blending may be necessary.

In examples where multiple sets of data and dynamically generated features are used to generate a simulated version of the golf course, information confirmed to accurately represent actual conditions may be prioritized over information representing an informed guess at such conditions. For example, the first set of data may be prioritized over the second set of data, and the first set of data and the second set of data may be prioritized over the dynamically, on-the-fly generated features when defining the playing surface of the golf course and when defining the features of the golf course for simulation.

In some examples, instructions to delete the golf course for simulation after simulation is finished may be included with the instructions for simulating the golf course for simulation instructions before transmitting the instructions for simulating the golf course for simulation for receipt by the client device (at act 214). For example, the instructions for simulating the golf course may include confidential and proprietary data, such as, for example, data from the first set of data, which may not be permanently stored on the client device. Thus, the instructions may ensure that such data is deleted after simulation of the golf course is completed. Further, any local copies of the golf course for simulation may be deleted by the transmitting device (e.g., a server) after transmitting the instructions for simulating the golf course for simulation for receipt by the client device.

In some examples, a computer 112 (see FIG. 1) of a golf simulator system 100 (see FIG. 1) may locally generate and execute the instructions for simulating the golf course. In other examples, the computer 112 (see FIG. 1) of the golf simulator system 100 (see FIG. 1) may receive the instructions for simulating the golf course from another network-connected device (e.g., a server). Consistent with at least the immediately preceding two examples, the instructions for simulating the golf course for simulation may be generated by one or more remote devices (e.g., one or more servers) and sent for execution by a client device to cause the client device to display and simulate golf played on the golf course for simulation responsive to user input. In still other examples, the instructions for simulating the golf course for simulation may be generated and executed by a network-connected device (e.g., a server), and only information for displaying the simulation may be transmitted (e.g., streamed) to the client device to simulate the golf course for a user.

In some examples, various actions in furtherance of generating instructions for simulating a golf course on demand may be performed in parallel with one another. For example, the playing surface may be defined while various flora, terrain, and associated textures and digital assets associated with the course itself or the region in which the course is situated may be accomplished at least partially contemporaneously. Such contemporaneous processing may reduce delays between acceptance of a request to simulate a course and delivery of instructions for simulating that course. Contemporaneous processing may be accomplished by, for example, employing different threads within a single, multithreaded processor or utilizing multiple processors in parallel to perform the actions (e.g., multiple processors within a server or group of services, a processor at a server and a processor at a client), also referred to as “distributed computing.”

In some examples, resources available for simulating the course may also alter the way in which the instructions for simulating the course are generated. For example, instructions may include fewer features and lower resolution when it is known or anticipated that those instructions will be executed on a device having a slow processor or limited memory, whereas instructions may include more features and higher resolution when it is known or anticipated that those instructions will be executed on a device having a fast processor or ample memory. As another example, instructions may include fewer features and lower resolution when limited resources are available for generating those instructions (e.g., at high-traffic times), whereas instructions may include more features and higher resolution when ample resources are available (e.g., at low-traffic times).

The golf course for simulation may be displayed on, for example, a display of the client device responsive to receiving the instructions for simulating the golf course for simulation. In examples where the client device is at least substantially similar to the golf simulator system 100 of FIG. 1, the golf course for simulation may be displayed on a display 110 (e.g., screen, projected image on a surface) of the golf simulator system 100. In some examples, the golf course for simulation may be mirrored on multiple displays. Displaying the golf course for simulation may involve, for example, displaying the textures from the database of textures and the digital assets from the database of digital assets within the features of the golf course for simulation corresponding to the at least some of the discrete regions from the first set of data.

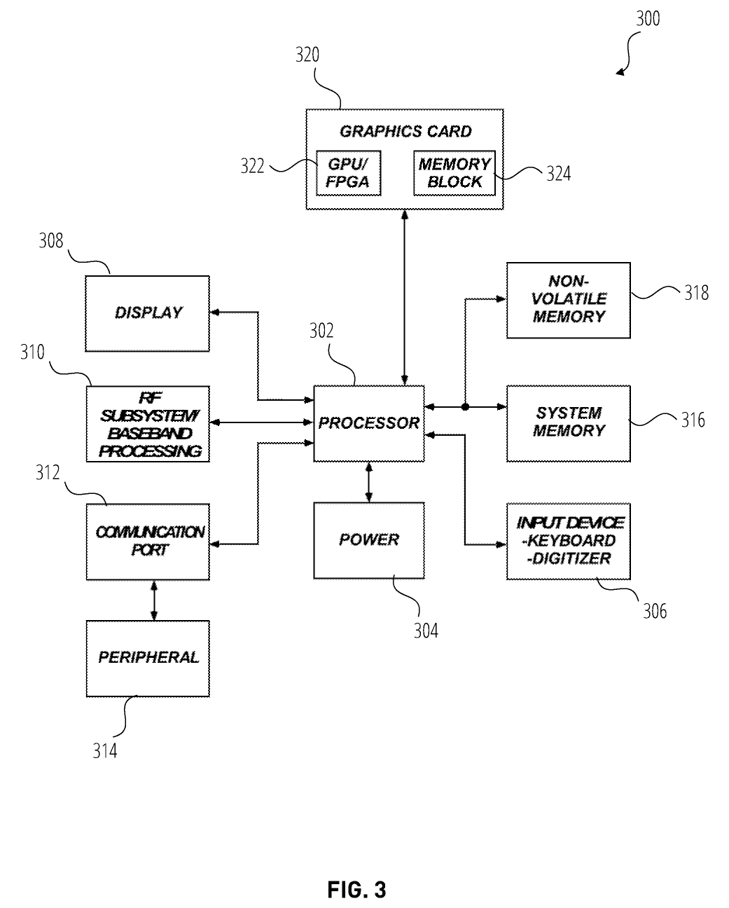

FIG. 3 is a block diagram of an electronic system 300 that may be included in one or more systems for simulating golf in accordance with this disclosure. For example, the electronic system 300 may be any of a variety of types, such as a computer, tablet, cellular phone, smartphone, control circuit, or other electronic device. The electronic system 300 may include one or more processors 302, such as a microprocessor, field-programmable gate array (FPGA), or combination of a microprocessor and FPGA, to control the processing of system functions and requests in the electronic system 300. In some embodiments, the electronic system 300 may be incorporated into a golf simulator system 100, as shown and described in connection with FIG. 1.

The electronic system 300 may include a power supply 304 in operable communication with the processor 302. For example, if the electronic system 300 is a portable system, the power supply 304 may include one or more of a fuel cell, a power scavenging device, permanent batteries, replaceable batteries, and/or rechargeable batteries. The power supply 304 may also include an AC adapter; therefore, the electronic system 300 may be plugged into a wall outlet, for example.

Various other devices may be coupled to the processor 302 depending on the functions that the electronic system 300 performs. For example, an input device 306 may be operatively connected to the processor 302. The input device 306 may include, for example, buttons, switches, a keyboard, a light pen, a mouse, a digitizer and stylus, a touch screen, a touch pad, a voice recognition system, a microphone, or any combination or subcombination thereof. A display 308 may also be operatively connected to the processor 302. The display 308 may include a liquid crystal display (LCD), a surface-conduction electron-emitted display (SED), a cathode-ray tube (CRT) display, a digital light processing (DLP) display, a plasma display, an organic light-emitting diode (OLED) display, a light-emitting diode (LED) display, a three-dimensional projection, an audio display, a projection screen display, or a combination thereof.

An RF sub-system/baseband processor 310 may also be operatively connected to the processor 302. The RF sub-system/baseband processor 310 may include an antenna that is coupled to an RF receiver and to an RF transmitter (not shown). A communication port 312, or more than one communication port 312, may also be operatively connected to the processor 302. The communication port 312 may be adapted to be connected to one or more peripheral devices 314, such as, for example, a modem, a printer, a computer, a scanner, or a camera, or to a network, such as a local area network, remote area network, intranet, or the Internet, for example.

The processor 302 may control the electronic system 300 by executing software programs stored in one or more memory devices 316, 318 (also referred to herein as “memory device 316” and “memory device 318”). The software programs may include an operating system, database software, drafting software, word processing software, media editing software, or media playing software, for example. The memory device(s) 316, 318 may be operatively connected to the processor 302 to store and facilitate execution of various programs. For example, the processor 302 may be coupled to system memory 316, which may include one or more of spin torque transfer magnetic random access memory (STT-MRAM), magnetic random access memory (MRAM), dynamic random access memory (DRAM) (e.g., synchronous DRAM (SDRAM) conforming with a double data rate (DDR) and/or graphics DDR (GDDR) standard (DDR4, DDR5, DDR6)), static random access memory (SRAM), racetrack memory, and other known memory types. The system memory 316 may include volatile memory, non-volatile memory, or a combination thereof. The system memory 316 may typically be large so that it can store dynamically loaded applications and data.

The processor 302 may also be coupled to a memory device, which is a non-volatile memory and may be referred to herein as “non-volatile memory 318,” which is not to suggest that system memory 316 is necessarily volatile. The non-volatile memory 318 may include one or more of STT-MRAM, MRAM, read-only memory (ROM) such as an EPROM, resistive read-only memory (RROM), and flash memory to be used in conjunction with the system memory 316. The size of the non-volatile memory 318 may typically be selected to be just large enough to store any necessary operating system, application programs, and fixed data. Additionally, the non-volatile memory 318 may include a high-capacity memory such as disk drive memory, a hybrid-drive including resistive memory, or other types of non-volatile solid-state memory, for example.

In some embodiments, the electronic system 300 may include a graphics subsystem, such as a graphics card 320, operatively connected to the processor 302. For example, each of the graphics card 320 and the processor 302 may be connected to, and supported on, a motherboard in their respective sockets (e.g., a peripheral component interconnect express (PCIe) socket for the graphics card 320, a CPU socket for the processor 302). The graphics card 320 may include its own processing device, such as a graphics processing unit (GPU) or FPGA 322. The GPU or FPGA 322 may be configured to, and may be a dedicated device for, processing graphics-related tasks to accelerate the creation of images in a frame buffer intended for output to the display 308. The graphics card 320 may also include a memory bank, such as, for example, a graphics memory block 324, which may include one or more high-speed memory devices connected to the GPU or FPGA 322 and configured to store and facilitate acceleration of graphics-related data. More specifically, the graphics memory block 324 may include one or more banks of devices configured as dynamic random access memory (DRAM) (e.g., synchronous DRAM (SDRAM) conforming with a double data rate (DDR) and/or graphics DDR (GDDR) standard (GDDR5, GDDR6, GDDR7)).

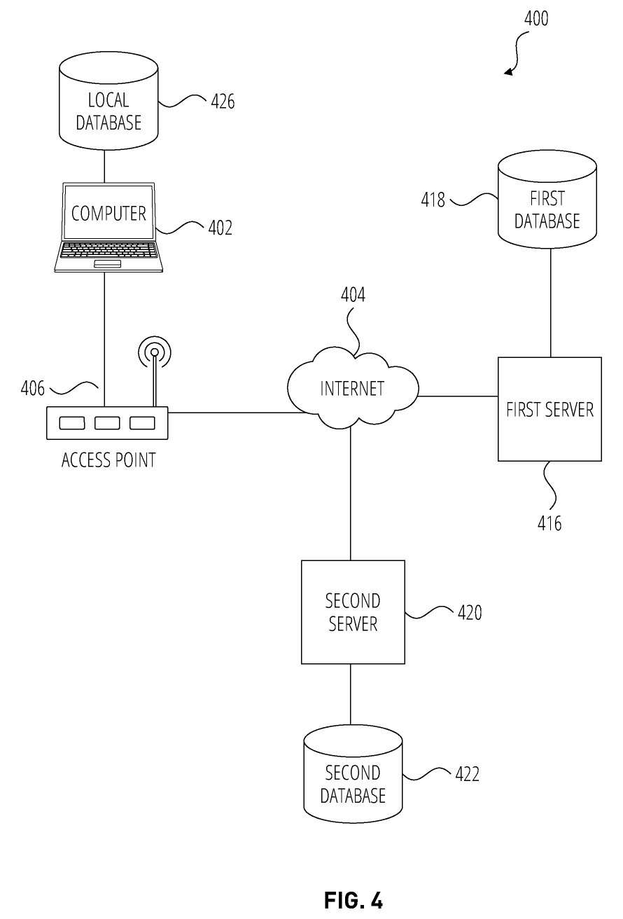

FIG. 4 is a schematic block diagram of a network 400 of electronic systems, which may embody, be included in, or be connected to one or more systems for simulating golf. The network 400 may include one or more computers 402. Each computer 402 may be configured as an electronic system 300 at least substantially as shown and described in connection with FIG. 3. For example, the computer 402 may be a desktop, all-in-one, laptop, tablet, two-in-one laptop and tablet, smartphone, or other computing device.

The computer 402 may be communicatively connected to a remainder of, and form part of, the network 400. For example, the network 400 may be a local area network (LAN), a wide area network (WAN), or the Internet 404. As a specific, nonlimiting example, a communication port 312 (see FIG. 3) of the computer 402 may be connected to an access point 406 (e.g., a router, a modem, a combination router and modem), which may in turn be connected to, and grant access to, the Internet 404.

Connection to the network 400 may enable the computer 402 to access, communicate with, receive communications from, and otherwise interact with other network-connected devices. For example, the computer 402 may send requests to, and receive responses from, a first server 416. The first server 416 may, for example, host or otherwise grant access to a first database 418, which may include the first set of data identifying discrete regions of the golf course for simulation. The first server 416 and/or the associated first database 418 may not be accessible without restriction in some examples. Any requests, other communications, or other connections to the first server 416 and/or the associated first database 418 in such examples may require the provision of credentials or other confirmation that the computer 402 is authorized to access resources available from the first server 416 and/or the associated first database 418. In some examples, the request to provide resources from the first server 416 and/or the associated first database 418 may not come directly from the computer 402. For example, the computer 402 may initiate a request, first send the request to an intermediary (e.g., a server operated by a provider of the golf simulation services), which may then forward the request or generate a new request to the first server 416 and/or the associated first database 418.

The computer 402 may also send requests to, and receive responses from, for example, a second server 420. The second server 420 may, for example, host or otherwise grant access to a second database 422, which may include the second set of data identifying geographical coordinates representative of the golf course for simulation. The first server 416 and/or the associated first database 418 may be publicly accessible without restriction in some examples. In some examples, the request to provide resources from the second server 420 and/or the associated second database 422 may come directly from the computer 402. For example, the computer 402 may initiate a request and send the request to second server 420 (e.g., a server operated by a provider of the golf simulation services).

In some examples, the computer 402 may contain or have access to a local database 426. For example, the local database 426 may be stored in memory 316, 318 (see FIG. 3) of the computer 402. The local database 426 may contain some or all of the data necessary for generating the golf course for simulation. For example, the local database 426 may embody or include a database of textures and a database of digital assets, which may include textures and digital assets for populating at least some, and in some examples all, of the features of the golf course for simulation from the first set of data. In examples where generation of the golf course for simulation is accomplished partially or completely locally, the first set of data and/or the second set of data may be stored in or transferred to the local database 426.

Apparatuses, systems, methods, and other subject matter within the scope of this disclosure may enable generation of a higher resolution, higher fidelity, more densely populated with features, and/or more accurate golf simulation when compared to golf courses for simulation generated using other techniques known to the inventors. For example, techniques in accordance with this disclosure may enable on-demand generation of a golf course for simulation when pregenerated data representative of the golf course for simulation is not available or when generating the golf course for simulation on demand would result in improved player experience. In addition, generating golf courses for simulation on demand may enable golf simulation to be provided for a much wider variety of golf courses, such as, for example, courses that are local to a user, courses that are not part of a professional tour, courses that are not famous, and courses that have not been analyzed by the provider of the golf simulation. Generating such golf courses for simulation on demand may reduce the need to gather and process detailed scan data for a golf course and may reduce the need to generate custom digital assets, such as, for example, custom trees or other flora, to represent the golf course for simulation.

Additional, nonlimiting examples within the scope of this disclosure include:

Example 1: A computer-readable storage medium, comprising instructions that, when executed by a processor, cause the processor to: accept a request to provide a golf course for simulation; request a first set of data identifying discrete regions of the golf course for simulation from a first database; responsive to receiving the first set of data, generate instructions for simulating the golf course for simulation, comprising: defining a playing surface of the golf course for simulation at least partially utilizing the discrete regions of the first set of data; defining features of the golf course for simulation comprising hole location, green area, fairway area, and tee location at least partially utilizing the discrete regions of the first set of data; and generating instructions for populating the features of the golf course for simulation with textures from a database of textures and digital assets from a database of digital assets corresponding to the at least some of the discrete regions from the first set of data; and transmit the instructions for simulating the golf course for simulation for receipt by a client device to cause the client device to display and simulate golf played on the golf course for simulation responsive to user input.

Example 2: The computer-readable storage medium of claim 1, wherein the instructions are further configured to cause the processor to: request a second set of data identifying geographical coordinates representative of the golf course for simulation from a second database; and smooth at least one transition between the discrete regions of the first set of data or between the discrete regions of the first set of data and a surrounding environment utilizing the geographical coordinates of the second set of data when defining the playing surface of the golf course for simulation.

Example 3: The computer-readable storage medium of Example 2, wherein the instructions are further configured to cause the processor to: define at least some of the features of the golf course for simulation by positioning dynamically, on-the-fly generated features other than hole location, green area, fairway area, and tee location within the golf course for simulation.

Example 4: The computer-readable storage medium of Example 3, wherein the instructions are further configured to cause the processor to: prioritize the first set of data over the second set of data and prioritize the first set of data and the second set of data over the dynamically, on-the-fly generated features when defining the playing surface of the golf course and when defining the features of the golf course for simulation.

Example 5: The computer-readable storage medium of any one of Examples 2 through 4, wherein the instructions are further configured to cause the processor to: analyze images corresponding to the golf course to be simulated from the first set of data, the second set of data, or the first set of data and the second set of data utilizing an artificial intelligence model trained to identify the features of the golf course; identify one or more features from the images not already present in the first set of data or the second set of data; and include the one or more features when defining the features of the golf course for simulation.

Example 6: The computer-readable storage medium of any one of Examples 2 through 5, wherein the instructions are further configured to cause the processor to: request the second set of data from a private database comprising confidential scan data; and if the private database does not include confidential scan data corresponding to the golf course for simulation, request the second set of data from a public database comprising global positioning system data.

Example 7: The computer-readable storage medium of any one of Examples 2 through 6, wherein the instructions are further configured to cause the processor to: request the first set of data identifying the discrete regions of the golf course for simulation at a first resolution from the first database; and request the second set of data identifying the geographical coordinates representative of the golf course for simulation at a second, more detailed resolution from the second database.

Example 8: The computer-readable storage medium of any one of Examples 2 through 7, wherein the instructions are further configured to cause the processor to: compare the first set of data to the second set of data and modify the shape, position, or shape and position of the discrete regions of the golf course for simulation responsive to detected shapes and positions of the geographical coordinates representative of the golf course for simulation before defining the features of the golf course for simulation.

Example 9: The computer-readable storage medium of Example 8, wherein the instructions are further configured to cause the processor to: modify the shape, position, or shape and position of the discrete regions of the golf course for simulation by comparing first elevation data from the first set of data to second elevation data from the second set of data and, when the first elevation data does not match the second elevation data, using the second elevation data for the playing surface and for the features of the golf course for simulation.

Example 10: The computer-readable storage medium of any one of Examples 1 through 9, wherein the instructions are further configured to cause the processor to: include textures and digital assets representative of flora prevalent in and around geographical coordinates of the golf course for simulation when generating the instructions for populating the features of the golf course for simulation with the textures and the digital assets.

Example 11: The computer-readable storage medium of any one of Examples 1 through 10, wherein the instructions are further configured to cause the processor to: include textures and digital assets representative of terrain prevalent in and around geographical coordinates of the golf course for simulation when generating the instructions for populating the features of the golf course for simulation with the textures and the digital assets.

Example 12: The computer-readable storage medium of any one of Examples 1 through 11, wherein the instructions are further configured to cause the processor to: include with the instructions for simulating the golf course for simulation instructions to delete the golf course for simulation after simulation is finished before transmitting the instructions for simulating the golf course for simulation for receipt by the client device; and delete any local copies of the golf course for simulation after transmitting the instructions for simulating the golf course for simulation for receipt by the client device.

Example 13: A method of simulating golf, comprising: accepting a request to provide a golf course for simulation; requesting a first set of data identifying discrete regions of the golf course for simulation from a first database; responsive to receiving the first set of data, generating instructions for simulating the golf course for simulation, comprising: defining a playing surface of the golf course for simulation at least partially utilizing the discrete regions of the first set of data; defining features of the golf course for simulation comprising hole location, green area, fairway area, and tee location at least partially utilizing the discrete regions of the first set of data; and generating instructions for populating the features of the golf course for simulation with textures from a database of textures and digital assets from a database of digital assets corresponding to the at least some of the discrete regions from the first set of data; and transmitting the instructions for simulating the golf course for simulation for receipt by a client device to cause the client device to display and simulate golf played on the golf course for simulation responsive to user input.

Example 14: The method of Example 13, further comprising: requesting a second set of data identifying geographical coordinates representative of the golf course for simulation from a second database; and smoothing at least one transition between the discrete regions of the first set of data or between the discrete regions of the first set of data and a surrounding environment utilizing the geographical coordinates of the second set of data when defining the playing surface of the golf course for simulation.

Example 15: The method of Example 14, further comprising: analyzing images corresponding to the golf course to be simulated from the first set of data, the second set of data, or the first set of data and the second set of data utilizing an artificial intelligence model trained to identify the features of the golf course; identifying one or more features from the images not already present in the first set of data or the second set of data; and including the one or more features when defining the features of the golf course for simulation.

Example 16: The method of Example 14 or Example 15, further comprising: requesting the first set of data identifying the discrete regions of the golf course for simulation at a first resolution from the first database; and requesting the second set of data identifying the geographical coordinates representative of the golf course for simulation at a second, more detailed resolution from the second database.

Example 17: The method of any one of Examples 13 through 16, further comprising: including with the instructions for simulating the golf course for simulation instructions to delete the golf course for simulation after simulation is finished before transmitting the instructions for simulating the golf course for simulation for receipt by the client device; and deleting any local copies of the golf course for simulation after transmitting the instructions for simulating the golf course for simulation for receipt by the client device.

Example 18: The method of any one of Examples 13 through 17, further comprising displaying the golf course for simulation on a display of the client device responsive to receiving the instructions for simulating the golf course for simulation.

Example 19: The method of Example 18, wherein displaying the golf course for simulation comprises displaying the textures from the database of textures and the digital assets from the database of digital assets within the features of the golf course for simulation corresponding to the at least some of the discrete regions from the first set of data.

Example 20: A system for simulating golf, comprising: a sensor positioned and configured to detect a trajectory of a ball; a display positioned and configured to display a golf simulation; a processor operatively connected to the display; and a computer-readable storage medium operatively connected to the processor, the computer-readable storage medium storing instructions that, when executed by a processor, cause the system to: accept a request to provide a golf course for simulation; initiate a request for a first set of data identifying discrete regions of the golf course for simulation from a first database; responsive to receipt of the first set of data, initiate generation of instructions for simulating the golf course for simulation, comprising: initiating definition of a playing surface of the golf course for simulation at least partially utilizing the discrete regions of the first set of data; initiating definition of features of the golf course for simulation comprising hole location, green area, fairway area, and tee location at least partially utilizing the discrete regions of the first set of data; and initiating generation of instructions for populating the features of the golf course for simulation with textures from a database of textures and digital assets from a database of digital assets corresponding to the at least some of the discrete regions from the first set of data; and receive the instructions for simulating the golf course for simulation to cause the display to display and the system to simulate golf played on the golf course for simulation responsive to user input received at the sensor.

While certain illustrative examples have been described in connection with the figures, those of ordinary skill in the art will recognize and appreciate that the scope of this disclosure is not limited to those examples explicitly shown and described in this disclosure. Rather, many additions, deletions, and modifications to the embodiments described in this disclosure may be made to produce examples of subject matter within the scope of this disclosure, such as those specifically claimed, including legal equivalents. In addition, features from one disclosed example may be combined with features of another disclosed example while still being within the scope of this disclosure.

What is claimed is:

1. A computer-readable storage medium, comprising instructions that, when executed by a processor, cause the processor to:
accept a request to provide a golf course for simulation;
request a first set of data identifying discrete regions of the golf course for simulation from a first database;
responsive to receiving the first set of data, generate instructions for simulating the golf course for simulation, comprising:
defining a playing surface of the golf course for simulation at least partially utilizing the discrete regions of the first set of data;
defining features of the golf course for simulation comprising hole location, green area, fairway area, and tee location at least partially utilizing the discrete regions of the first set of data; and
generating instructions for populating the features of the golf course for simulation with textures from a database of textures and digital assets from a database of digital assets corresponding to the at least some of the discrete regions from the first set of data; and
transmit the instructions for simulating the golf course for simulation for receipt by a client device to cause the client device to display and simulate golf played on the golf course for simulation responsive to user input.

2. The computer-readable storage medium of claim 1, wherein the instructions are further configured to cause the processor to:
request a second set of data identifying geographical coordinates representative of the golf course for simulation from a second database; and
smooth at least one transition between the discrete regions of the first set of data or between the discrete regions of the first set of data and a surrounding environment utilizing the geographical coordinates of the second set of data when defining the playing surface of the golf course for simulation.

3. The computer-readable storage medium of claim 2, wherein the instructions are further configured to cause the processor to:
define at least some of the features of the golf course for simulation by positioning dynamically, on-the-fly generated features other than hole location, green area, fairway area, and tee location within the golf course for simulation.

4. The computer-readable storage medium of claim 3, wherein the instructions are further configured to cause the processor to:
prioritize the first set of data over the second set of data and prioritize the first set of data and the second set of data over the dynamically, on-the-fly generated features when defining the playing surface of the golf course and when defining the features of the golf course for simulation.

5. The computer-readable storage medium of claim 2, wherein the instructions are further configured to cause the processor to:
analyze images corresponding to the golf course to be simulated from the first set of data, the second set of data, or the first set of data and the second set of data utilizing an artificial intelligence model trained to identify the features of the golf course;
identify one or more features from the images not already present in the first set of data or the second set of data; and
include the one or more features when defining the features of the golf course for simulation.

6. The computer-readable storage medium of claim 2, wherein the instructions are further configured to cause the processor to:
request the second set of data from a private database comprising confidential scan data; and
if the private database does not include confidential scan data corresponding to the golf course for simulation, request the second set of data from a public database comprising global positioning system data.

7. The computer-readable storage medium of claim 2, wherein the instructions are further configured to cause the processor to:
request the first set of data identifying the discrete regions of the golf course for simulation at a first resolution from the first database; and
request the second set of data identifying the geographical coordinates representative of the golf course for simulation at a second, more detailed resolution from the second database.

8. The computer-readable storage medium of claim 2, wherein the instructions are further configured to cause the processor to:
compare the first set of data to the second set of data and modify the shape, position, or shape and position of the discrete regions of the golf course for simulation responsive to detected shapes and positions of the geographical coordinates representative of the golf course for simulation before defining the features of the golf course for simulation.

9. The computer-readable storage medium of claim 8, wherein the instructions are further configured to cause the processor to:
modify the shape, position, or shape and position of the discrete regions of the golf course for simulation by comparing first elevation data from the first set of data to second elevation data from the second set of data and, when the first elevation data does not match the second elevation data, using the second elevation data for the playing surface and for the features of the golf course for simulation.

10. The computer-readable storage medium of claim 1, wherein the instructions are further configured to cause the processor to:
include textures and digital assets representative of flora prevalent in and around geographical coordinates of the golf course for simulation when generating the instructions for populating the features of the golf course for simulation with the textures and the digital assets.

11. The computer-readable storage medium of claim 1, wherein the instructions are further configured to cause the processor to:
include textures and digital assets representative of terrain prevalent in and around geographical coordinates of the golf course for simulation when generating the instructions for populating the features of the golf course for simulation with the textures and the digital assets.

12. The computer-readable storage medium of claim 1, wherein the instructions are further configured to cause the processor to:
include with the instructions for simulating the golf course for simulation instructions to delete the golf course for simulation after simulation is finished before transmitting the instructions for simulating the golf course for simulation for receipt by the client device; and
delete any local copies of the golf course for simulation after transmitting the instructions for simulating the golf course for simulation for receipt by the client device.

13. A method of simulating golf, comprising:
accepting a request to provide a golf course for simulation;
requesting a first set of data identifying discrete regions of the golf course for simulation from a first database;
responsive to receiving the first set of data, generating instructions for simulating the golf course for simulation, comprising:
defining a playing surface of the golf course for simulation at least partially utilizing the discrete regions of the first set of data;
defining features of the golf course for simulation comprising hole location, green area, fairway area, and tee location at least partially utilizing the discrete regions of the first set of data; and
generating instructions for populating the features of the golf course for simulation with textures from a database of textures and digital assets from a database of digital assets corresponding to the at least some of the discrete regions from the first set of data; and
transmitting the instructions for simulating the golf course for simulation for receipt by a client device to cause the client device to display and simulate golf played on the golf course for simulation responsive to user input.

14. The method of claim 13, further comprising:
requesting a second set of data identifying geographical coordinates representative of the golf course for simulation from a second database; and
smoothing at least one transition between the discrete regions of the first set of data or between the discrete regions of the first set of data and a surrounding environment utilizing the geographical coordinates of the second set of data when defining the playing surface of the golf course for simulation.

15. The method of claim 14, further comprising:
analyzing images corresponding to the golf course to be simulated from the first set of data, the second set of data, or the first set of data and the second set of data utilizing an artificial intelligence model trained to identify the features of the golf course;
identifying one or more features from the images not already present in the first set of data or the second set of data; and
including the one or more features when defining the features of the golf course for simulation.

16. The method of claim 14, further comprising:
requesting the first set of data identifying the discrete regions of the golf course for simulation at a first resolution from the first database; and
requesting the second set of data identifying the geographical coordinates representative of the golf course for simulation at a second, more detailed resolution from the second database.

17. The method of claim 13, further comprising:
including with the instructions for simulating the golf course for simulation instructions to delete the golf course for simulation after simulation is finished before transmitting the instructions for simulating the golf course for simulation for receipt by the client device; and
deleting any local copies of the golf course for simulation after transmitting the instructions for simulating the golf course for simulation for receipt by the client device.

18. The method of claim 13, further comprising displaying the golf course for simulation on a display of the client device responsive to receiving the instructions for simulating the golf course for simulation.

19. The method of claim 18, wherein displaying the golf course for simulation comprises displaying the textures from the database of textures and the digital assets from the database of digital assets within the features of the golf course for simulation corresponding to the at least some of the discrete regions from the first set of data.

20. A system for simulating golf, comprising:
a sensor positioned and configured to detect a trajectory of a ball;
a display positioned and configured to display a golf simulation;
a processor operatively connected to the display; and
a computer-readable storage medium operatively connected to the processor, the computer-readable storage medium storing instructions that, when executed by a processor, cause the system to:
accept a request to provide a golf course for simulation;
initiate a request for a first set of data identifying discrete regions of the golf course for simulation from a first database;
responsive to receipt of the first set of data, initiate generation of instructions for simulating the golf course for simulation, comprising:
initiating definition of a playing surface of the golf course for simulation at least partially utilizing the discrete regions of the first set of data;
initiating definition of features of the golf course for simulation comprising hole location, green area, fairway area, and tee location at least partially utilizing the discrete regions of the first set of data; and
initiating generation of instructions for populating the features of the golf course for simulation with textures from a database of textures and digital assets from a database of digital assets corresponding to the at least some of the discrete regions from the first set of data; and
receive the instructions for simulating the golf course for simulation to cause the display to display and the system to simulate golf played on the golf course for simulation responsive to user input received at the sensor.
